(19) United States
(12) Patent Application Publication
(10) Pub. No.: US 2018/0172371 A1
(43) Pub. Date: Jun. 21, 2018

(54) Coil Brush

(71) Applicant: Charles E. Thaggard, Hattiesburg, MS (US)

(72) Inventor: Charles E. Thaggard, Hattiesburg, MS (US)

(21) Appl. No.: 15/387,642

(22) Filed: Dec. 21, 2016

(51) Int. Cl. F28G 1/02; A46B 9/02; A46B 3/02; B25G 1/06; A46B 5/00

(52) U.S. Cl. CPC F28G 1/02; A46B 9/025; A46B 5/0012; B25G 1/06; A46B 3/02

(57) ABSTRACT

The present invention provides a coil brush having one or more brush heads with any brush head parallel to any other. The brush heads may have a head base, a bristle slide or guide, and bundles or groups of straight and/or angled bristles, which may be interspersed in different arrangements in a head base of the head brush head, allowing for a variety of brushing planes. The coil brush may further comprise a rear mount handle or a detachable handle that allow the user to adjust the position of the brush to better access and clean coils in hard to reach places. The bristle slide allows the user to control the stiffness of the bundles of bristles by controlling the spreading of the bristles. This invention allows the brushing of coils in heating ventilation and air conditioning equipment at a variety of angles from a variety of coil access points.

### FIELD OF THE INVENTION

This invention relates in general to brush for cleaning the coils of a heating, ventilating, and air conditioning system (HVAC) and more specifically to an coil brush to clean the evaporator coils of the system.

### BACKGROUND OF THE INVENTION

Keeping evaporator coils clean greatly enhances the efficiency of and Air Conditioning System. Cleaning the coils without first removing them from the a/c system is difficult due to the geometry of the coil as well as proximity of the coil within the system. Evaporator coils have as many as four individual, flat surfaced coil sections that converge to form an “A”, “N”, or “M” shaped configuration. The convergent points leave very little room for access using any cleaning device. The coil fins themselves may be arranged in a parallel, adjacent pattern and are evenly spaced at 12 to 18 fins per inch. Debris settles on the surface of the coils as well as between these individual coil fins. With the close spacing of the fins it is very difficult to remove debris from between them. There are no comb type brushes specifically designed for cleaning evaporator coils. Various type brushes designed for other uses are generally used, i.e. cat hair brush, pot brush, wire welding brush. These do not address the issues of limited access, coil geometry, or limited space.

Currently used devices do not have the proper configuration to access the complete surface of the coil. They are either too big to fit in tight spaces or have insufficient properties to remove debris from the coil surface as well as between the coil fins.

### SUMMARY OF THE INVENTION

The present invention provides a coil brush comprising bundles or groups of bristles anchored in a head base of a brush head. In one embodiment the bundles of bristles may be aligned in the brush head and the bundles of bristles may be straight and/or bent bristles. The coil brush may be used by wrapping a user's hand around a head base of the brush head or an articulating handle that may be attached to the head base of the brush head. The articulating handle allows the coils to be cleaned from a variety of angles and accessed from a variety of access points. The individually spaced bristle bundles of the coil brush allow debris from between the fins of the coil as well as the surface of the coil to be accessed. An adjustable slide allows the user to adjust the stiffness of the bundles of bristles. The brush head may have a generally plate like head base with each of the bristle within the bundles of bristles having a mid portion extending from the head base head, and the mid portion located between a base portion of the bristle that is anchored in the head base and a forward portion of the bristle having a business end. Another embodiment of the present invention may include a first head base of bundles of bristles at a first bristle angle mounted on second head base with bundles of bristles at a second bristle angle. The first head base may have a rail that slides in a track on the second head base allowing the business ends of the first head base to slide forward of the business ends of the bundles of bristles of the second head base, or visa versa, to form the brushing plane. In yet another embodiment of the present invention may feature bristle bundles at the second bristle angle mounted in a sliding mount 215 that slides on the bristle bundles at the first bristle angle allowing the business end of the bristle bundles at the second angle to move forward of the business end of the bristle bundles at the first bristle angle. The bundles of bristles at the first bristle angle and the bundles of bristles at the second angle each have a slide that forward of the sliding mount to maintain the stiffness of the respective bundles. A still yet another embodiment of the present invention, the dual slide head coil brush 310, comprises bristle bundles at the first bristle angle mounted in a first slide head 470a, bristle bundles at the second bristle angle mounted in a second slide head 470b, a master slide head 470c, a slide forward of the master slide on each of the bristle bundles at the first bristle angle and the bristle bundles at the second bristle angle, and a handle attached to the master slide. While the bristle bundles may be bundles of straight bristles, or bundles of bent bristles that are bent at some bristle angle, there may be bundles of hook shaped bristles that feature bristles having a hooked shaped forward portion. The simple and thin head base profile, the ability to employ a variety of different heads having bundles of bristles that have straight bristles, bristles at diverse angles, and hook shaped bristles, and the variety of articulating rear mount and top mount handles allow access to the converging points of many different coil configurations and allow accessing the coil surfaces through restrictive points of entry.

Among the advantages of the present invention is the ability to perform with greater ease and efficiency the brushing or cleaning of the coils in hard to reach areas where a flexible cleaning tool is beneficial.

These and other features and advantages of the coil brush according to this invention may be discussed below with respect to various illustrative embodiments of the invention as defined by the claims.

### BRIEF DESCRIPTION OF THE DRAWINGS

FIG. 1 shows a top view of one embodiment of the present invention with an arrangement of bristle bundles with each bundle having one bristle and an optional handle rotated to show a side view;

FIG. 2 shows a side view of the head base of the brush head and the brush slide of the present invention with a forward portion of the bristle bent at a bristle angle;

FIG. 3 a view of a first bristle bundle with the forward portion of a first bristle bent at a first bristle angle, and a second bristle bundle with the forward portion of a second bristle bent at a second bristle angle;

FIG. 4 shows a sectional view along line 4-4 of FIG. 2

FIG. 5 shows a sectional view along line 5-5 of FIG. 2

FIG. 6A shows a side view of a head base first portion and a head base second portion of the head base of the one embodiment of the presentation, the coil brush, with a base portion of bristles between the head base first portion and the head base second portion.

FIG. 6B shows a side view of the head base of the brush head of one embodiment of the presentation with the forward portion bent, and a mid portion and the base portion of the bristles aligned along the mid base axis of the bristles;

FIG. 6C shows a sectional view along line 6C-6C of FIG. 6B;

FIG. 7 shows a side view of an optional handle of FIG. 1;

FIG. 8 shows a top view of the handle with the handle extended in a straight line;

FIG. 8A shows a sectional view along line 8A-8A of FIG. 8;

FIG. 8B shows a sectional view along line 8B-8B of FIG. 8;

FIG. 8C shows a sectional view along line 8C-8C of FIG. 8;

FIG. 9 shows a side view of second rear mount handle;

FIG. 10 shows of a side view of another embodiment of the coil brush;

FIG. 11 shows a side view of the another embodiment of the coil brush with a first head base and a second head base aligned;

FIG. 12 shows a sectional view of the along line 12-12 of FIG. 11;

FIG. 13 shows a side view of yet another embodiment of the coil brush;

FIG. 14 shows a top view of the yet another embodiment of the coil brush;

FIG. 15 shows a sectional view along line 15-15 of the yet another embodiment of the coil brush;

FIG. 16 shows a frontal the slide mount the yet another embodiment with the bristle bundles of the slide mount with the bristles aligned in a single row;

FIG. 17 shows a side view of still yet another embodiment of the present invention;

FIG. 18 shows another side view of the still yet another embodiment of the present invention with a removable handle attached;

FIG. 19 shows a top view of the still yet another embodiment of the present invention with the removable handle attached; and

FIG. 20 shows a sectional view along line 20-20 of FIG. 19

FIG. 21 shows a top view of the still yet another embodiment of the present invention;

FIG. 22 shows a sectional view along line 22-22 of FIG. 21;

FIG. 23 shows a view of the bottom side view of the removable handle; and

FIG. 24 shows a sectional view along line 24-24 of FIG. 23.

### DETAILED DESCRIPTION OF THE INVENTION

In the following detailed description of the numerous embodiments of the present invention, reference is made to the accompanying figures that are part of it. It is understood that other methods could be used and that structural changes may be made without departing from the scope of the present invention.

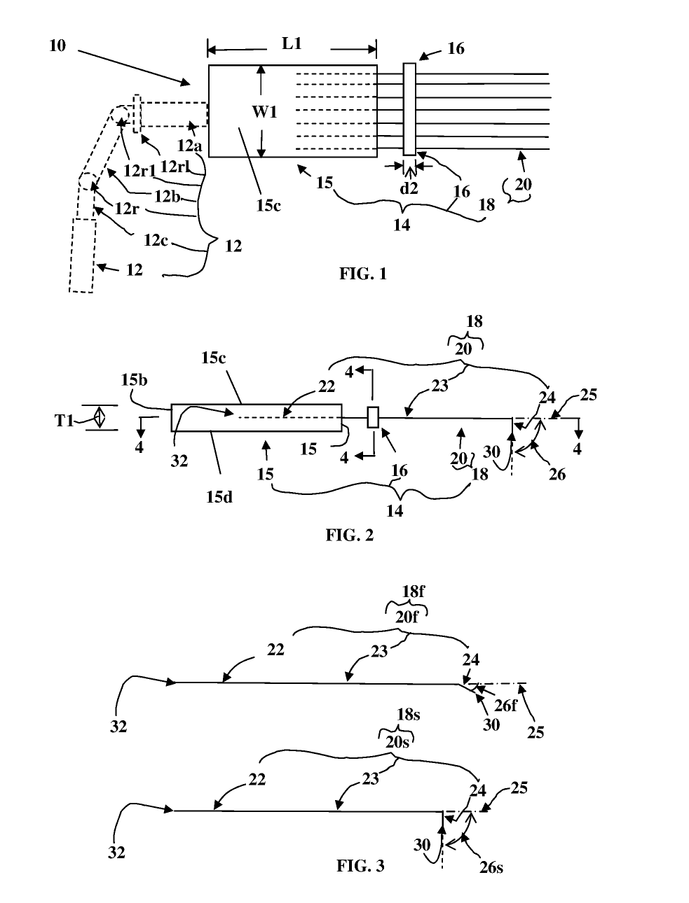

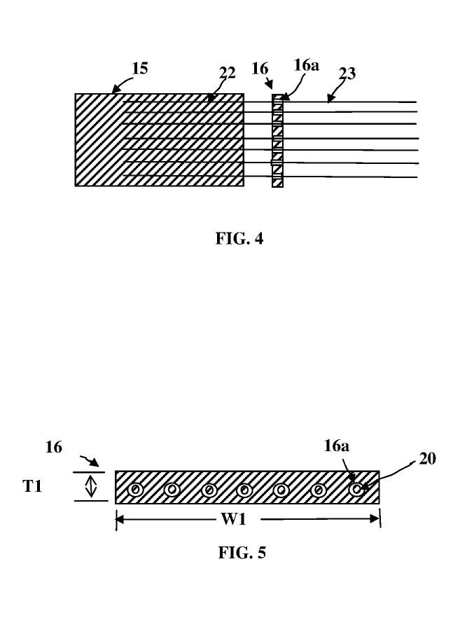

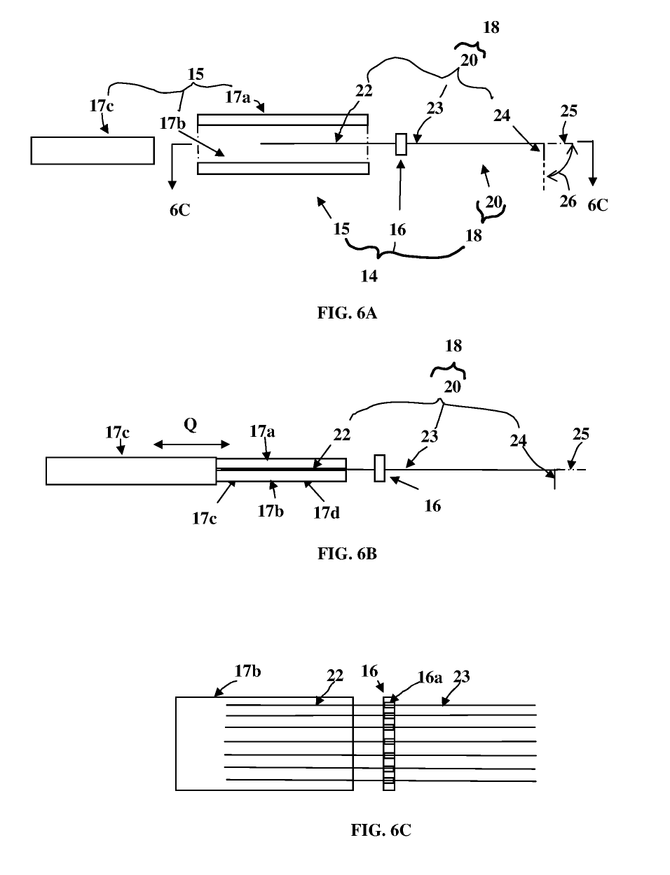

FIG. 1 depicts an illustration of one embodiment of the present invention, a coil brush 10. The coil brush 10 may include an optional handle, such as a rear mount handle 12, a brush head 14, and a bristle slide 16. The brush head 14 may be used to hold the coil brush 10 without the rear mount handle 12. The brush head 14 comprises a head base 15 having a head base forward end 15a and a head base rearward end 15b, a top base side 15c, and a bottom base side 15d, and one or more bristle bundles 18, with each bristle bundle 18 having at one or more bristles 20. Each of the one or more bristles 20 may comprise a base portion 22, a mid portion 23 and a forward portion 24 with the mid portion 23 located between the base portion 22 and the forward portion 24. Referring to FIG. 2, the mid portion 23 is an extension of the base portion 22 along a mid base axis 25. The forward portion 24 may be bent to form a bristle angle 26 with the mid base axis 25. Referring to FIG. 3, a coil brush 10 may also have bristle bundles 18 at different bristle angles 26, such as a first bristle bundle 18f having a first bristle 20f at a first bristle angle 26f and second bristle bundle 18s having a second bristle 20s at a second bristle angle 26s. Where the bristle angle is 0 degrees, the base portion 22, the mid portion 23, and the forward portion 24 will form a straight bristle (not shown). Looking to the second bristle bundle 18s, the second bristle angle 26s is about −90 degrees. Where the bristle angle, such as the second bristle angle 26s is greater than −90 degrees, a business end 30 (a distal end) of the second bristle 16s each would point back generally toward the head base end 32 that is located in the head base 15, thereby forming a hook or a hook shaped bristle. Referring to FIG. 4, a sectional view along line 4-4 of FIG. 2, the bristles 20 may be disposed with the mid portion 23 of the bristles 20 parallel to each other. Looking again to FIGS. 2 and 3, the bristle 20, first bristles 20f and second bristle, each have the business end 30 and a head base end 32, with the business ends 30 (the distal ends) of the bristles 20 forming the distal end of coil brush 10. The business ends 30 form the brushing plane that is a brush contact area with a targeted cleaning area, such as the coils of a heat, ventilating, and air conditioning (HVAC) system. The base portion 22 with the head base end 32 of the bristle 20 is anchored in the head base 15 of the coil brush 10. The head base forward end 15a maybe be drilled, and the base portion 22 of bristle 20 inserted in the head base 15 and held in place by a suitable adhesive, such as glue. Looking to FIG. 4, a sectional view along line 4-4 of FIG. 2, the bristle bundles 18 are placed in apertures 16a of the brush slide 16. Referring to FIG. 5, an exploded view sectional view along line 5-5 of FIG. 2, the brush slide 16 is shown with the bristles 20 disposed through the bristle apertures 16a of the brush slide 16, and the bristle apertures 16a aligned in a straight line. Referring to FIG. 6A, the head base 15 may comprise head base first portion 17a and a head base second portion 17b, and the bristle bundles 18 of the bristles 20 placed between a head base first portion 17a and a head base second portion 17b. The bristles 20 held in place by a suitable adhesive, such as glue, and/or a pressure of the head base first portion 17a against the bristles 20 and the head base second portion 17b. The head base first portion 17a and the head base second portion 17b may be held to each other by a screw 17c, a rivet 17d, an adhesive (not shown) with the bristle bundles 18 of bristles 20 inserted there between, or as shown in FIG. 6B, the head base first portion 17a and the head base second portion 17b may be wrapped by a head base covering 17c that slides over the head base 15 in wrap direction Q. Referring to FIG. 6C, a sectional view along line 6C-6C of FIG. 6A, the bristle bundles 18 are disposed through the bristle apertures 16a of the brush slide 16 and between the head base second portion 17b and the head base first portion 17a of FIG. 6B.

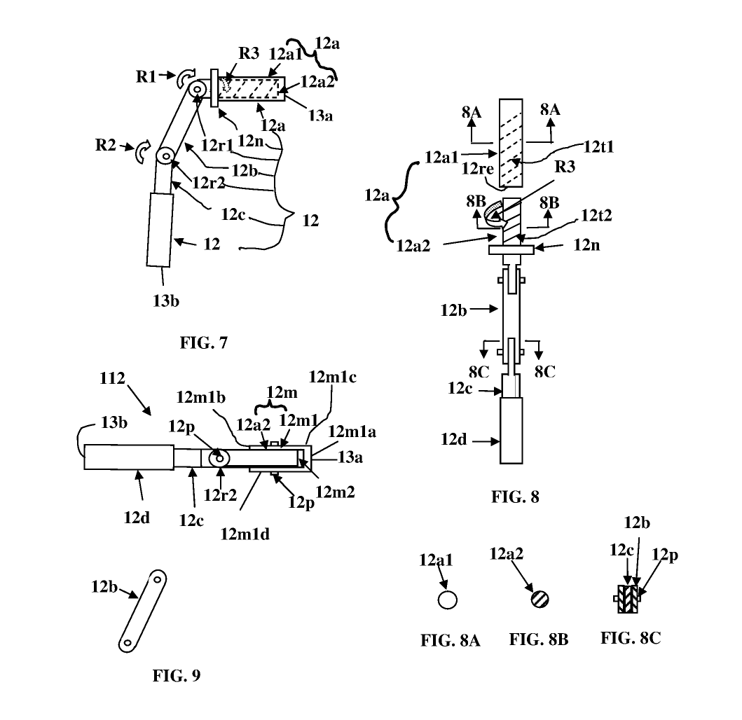

Referring to FIGS. 1 and 7, the optional handle, such as the rear mount handle 12, may have a first handle portion 12a, first rotary handle joint 12r1, a second handle portion 12b, a second rotary handle joint 12r2, and a third handle portion 12c. The first rotary handle joint 12r1 and the second rotary handle joint 12r2 allowing the handle to be disposed folded in first direction R1 and second direction R2. The first handle portion 12a may comprise a internally threaded cylinder portion 12a1 and an external threaded plug portion 12a2 with a threaded nut 12n on the plug portion 12a2 allowing the plug portion 12a2 to be fixed relative to the cylinder portion 12a1 once the plug portion 12a2 is rotating in path R3 to a desired position allowing the business end 30 of the bristles 20 to clean the intended target, such as coils of a heating ventilating and air conditioning (HVAC) unit. By rotating the plug portion 12a2, the second handle portion 12b and the third handle portion 12c may rotating in first direction R1 about the cylinder portion 12a1 that is fixed to the head base 15 of the brush head 14. Referring to FIG. 8A, a sectional view along line 8A-8A of FIG. 8 is shown. Referring to FIG. 8B, a sectional view along of the plug portion 12a2 along line 8B-8B of FIG. 8 is shown. Referring to FIG. 8C, a section view along line 8C-8C of FIG. 8 is shown illustrating the second handle portion 12b connected to the third handle portion 12c using a pin 12p. The plug portion 12a2 may have external threads 12t2 configured to fit internal treads 12t1 of the cylinder portion 12a1. The plug portion 12a2 may be screwed into or out of the cylinder portion 12a1 to achieve the desired position and then the locked by turning the threaded nut 12n, located on the plug portion 12a2, to seal against the rim edge 12re of the cylinder portion 12a1. The plug portion 12a2 allows the rear mount handle 12 to be rotated in the clockwise and counter clockwise direction around path R3 and locked in position with the threaded nut 12n. The rear mount handle 12 will have a handle first end 13a and a handle near end 13b, the handle first end 13a connected the head base rearward end 15b. Referring to FIG. 9 a second rear mount handle 112 is shown. The second handle portion 12b of FIG. 8 is removed and third handle portion 12c with the hand grip 12d connected at the second rotary handle joint 12r2 to the plug portion 12a2 using the pin 12p. The cylinder portion 12a1 of FIG. 8 may be replaced by a plate 12m with the plate 12m having a plate like slot 12m2 cut in a plate rearward end 12m1b as shown in FIG. 9. The plate 12m may be generally rectangular with a plate forward end 12m1a, a plate rearward end 12m1b, a plate top side 12m1c, and a plate bottom side 12m1d. The plug portion 12a2 may rotate about a plate pin 12p1 that is placed through the plate 12m and the plug portion 12a2. The plug portion 12a2 rotates about the plate pin 12p1 in a plane generally perpendicular to the plane of rotation of the third handle portion 12c that rotates about the pin 12p of second rotary handle joint 12r2. The plate pin 12p1 is inserted through the plate top side 12m1c, through the plug portion 12a2, an then through the plate bottom side 12m1d. The second rear mount handle 112 may be connected to the head base 15 by attaching a plate forward end 12m1a of the second rear mount handle 112 to the head base rearward end 15b of the head base 15.

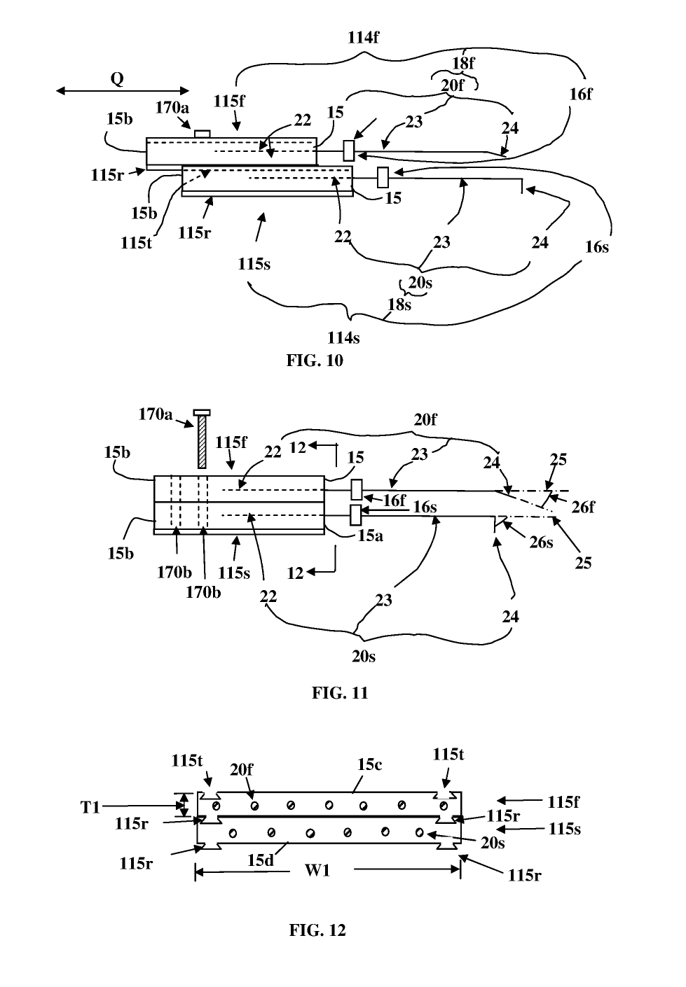

Looking to FIG. 10, another embodiment of the present invention, a dual head coil brush 110, is shown. The dual head coil brush 110 is comprised essentially of two copies of the one embedment of the present invention with a first copy of the coil brush 10 stacked on a second copy of the coil brush 10. One or more rails 115r are added to a head top side 15c of the head base 15 of the brush head 14 of the first copy of the coil brush 10 forming a first head base 115f of a first brush head 114f. One or more tracks 115t are added to a head top side 15c of the second head base 115s forming a second head base 115s. The head base 15 of the brush head 14 of the first copy of the coil brush 10 forms a first head base 115f of a first brush head 114f. At least one rail 114r is added to a head base 15 of a brush head 14 of the second copy of the coil brush 10 forming a second head base 115s of a second brush head 114s. Referring to FIG. 11, the first head base 115f and the second head base 115s may be locked in position by a screw 170a inserted in threaded apertures 170b on the first head base 115f and the second head base 115s. Referring to FIG. 12, a sectional view along line 12-12 for FIG. 11, the first head base 115f and the second head base 115s may have the one or more tracks 115t on one side, such as the head top side 15c, the one track 115t disposed parallel to any other track 115t on the head top side 15c. Also, first head base 115f and the second head base 115s may have one or more rails 115r on the other side, such as a head bottom side 15c, the one or more rails 115r parallel to any other rail on the bottom side 115d. The one or more rails 115r on the first head base 115f are disposed configured to fit in the one of more tracks 115t of the second head base 115s or visa versa. Although, two head bases, a first head base 115f and a second head base 115s, are shown in FIGS. 10-12, additional head bases may be stacked one upon the other in a like manner. The second rear mount handle 112, may be connected to the head base rearward end 15b of the first head base 115f by attaching the plate forward end 12m1a of the plate 12m to the head base rearward end 15b of the first head base 115f.

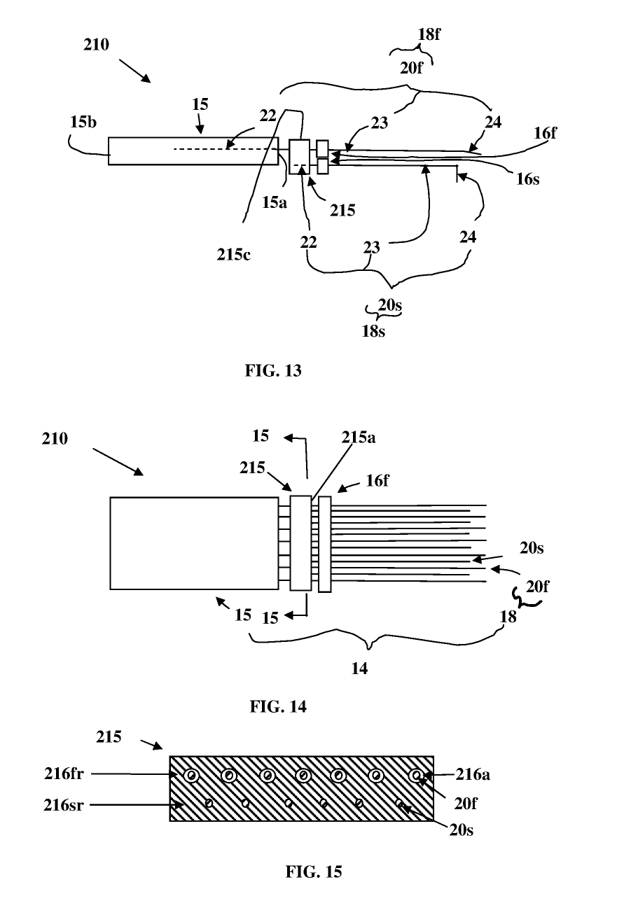

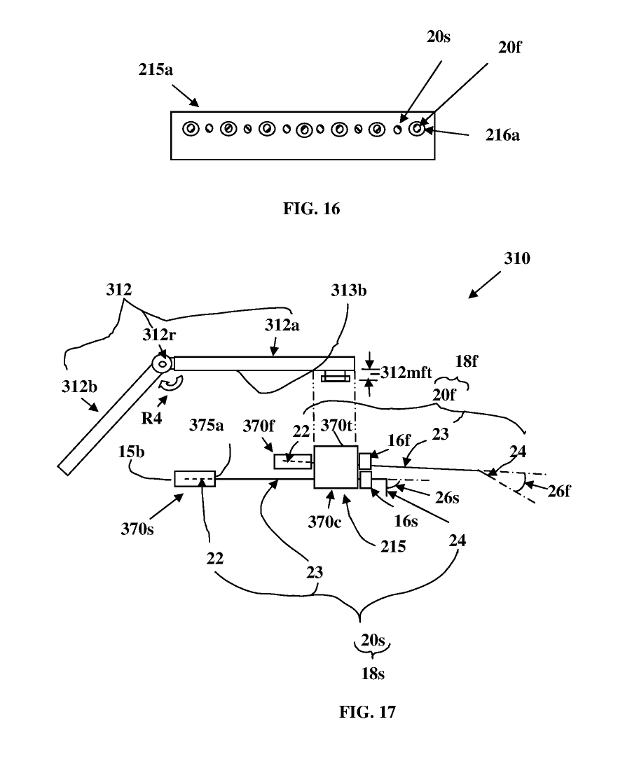

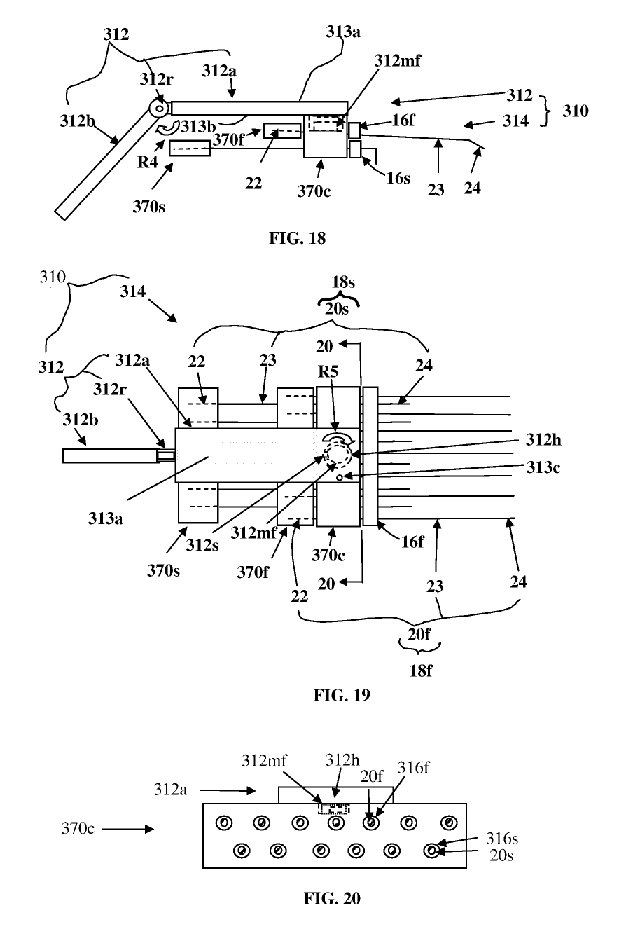

Referring to FIG. 13, a yet another embodiment of the present invention, a slide mount coil brush 210 is shown. The slide mount coil brush 210 has the second bristle bundles 18s at the second bristle angle 26s mounted in a slide mount 215 that slides on the first bristle bundles 18f at the first bristle angle 26f. The first bristle bundles 18f are mounted in the base head 15, allowing the business end 30 of the second bristle bundles 18s at the second bristle angle 26s to move forward of the business end 30 of the first bristle bundles 18f at the first bristle angle 26f. The first bristles 20f at the first bristle angle 26f have the first slide 16f forward of the slide mount 215 to maintain the stiffness and separation of the first bristles 20f, and the bundles of bristles at the second bristle angle 26s may have a second slide 16s forward of the slide mount 215 to maintain the stiffness and separation of the second bristles 20s, but the second slide 16s may be deleted when maintaining the stiffness and the separation are not required. The base portions 22 of the second bristles 20s may be mounted in the slide mount 215 is a manner similar to that of the base portion 22 of the bristle 20 mounted in the base head 15 of the one embodiment shown in FIG. 2. The second rear mount handle 112 of FIG. 9 may be connected to the slide mount 215 shown in FIG. 13 by attaching the plate bottom side 12m1d of the plate 12m in FIG. 9 to a slide mount top side 215c of FIG. 13 with a screw, a bolt, or an adhesive, such as glue.

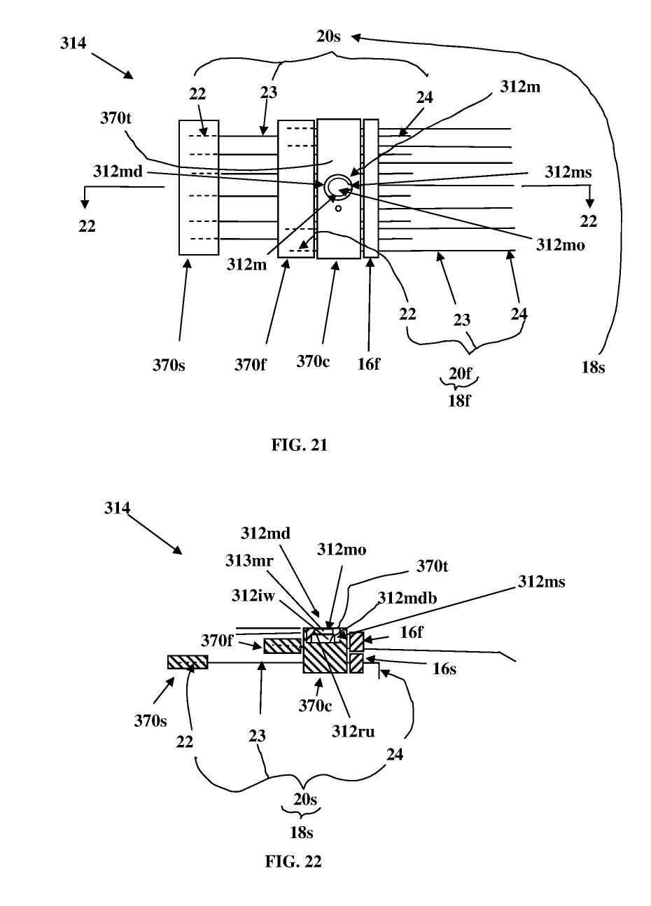

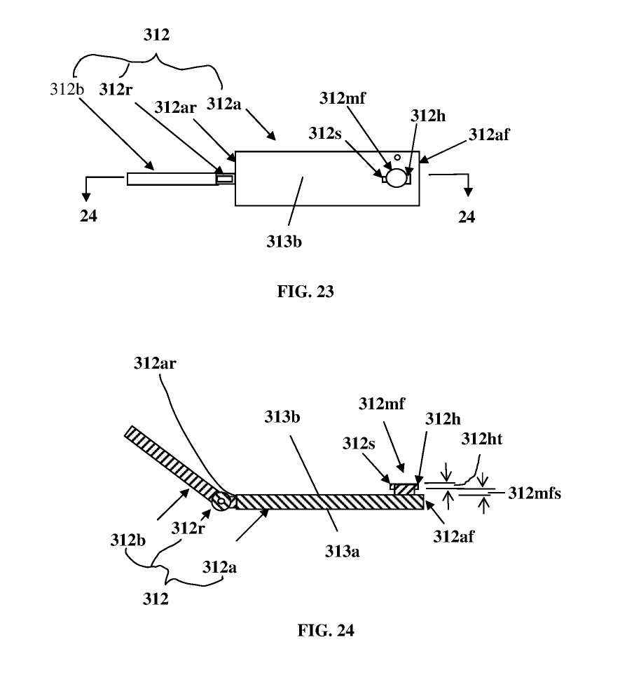

Referring to FIG. 17, a side view of a still yet another embodiment of the present invention, a dual slide head coil brush 310, is illustrated. The dual slide head coil brush 310 comprises: the first bristle bundles 18f with the first bristles 20f at the first bristle angle 26f mounted in a first slide head 370f; the second bristle bundles 18s at the second bristle angle 26s mounted in a second slide head 370s; a master slide 370c; a first slide 16f forward of the master slide 370c on each of the first bristle bundles 18f at the first bristle angle 26f; and the second slide 16s on the second bristle bundles 18s at the second bristle angle 26s; and a removable handle 312. The removable handle 312 has a removable first portion 312a that is attached the master slide 370c by inserting a mount foot 312mf into a mount depression 312md located on an upper side 370t of the master slide 370c. Referring to FIG. 21 and FIG. 22, the mount depression 312md may have a cylindrical opening 312co in a mount rim 312mr that has a mount slot 312ms, and referring to FIGS. 23 and 24, the mount slot 312ms is configured to allow a stub 312s positioned opposite a hold 312h on the mount foot 312mf to be inserted in the mount slot 312ms. To attach the removable handle 312 to the master slide 370c, the hold 312h is first placed in the cylindrical opening 312co of the mount depression 312md under the mount rim 312mr with the stub 312s aligned and inserted through the mount slot 312ms, and then the removable handle 312 rotated 180 degrees, placing the hold 312h beneath a portion of the mount rim 312mr adjacent to the mount slot 312ms, holding the removable handle 312 to the master slide 370c. The handle is detached by reversing the attachment procedure. The mount depression 312md may have a mount depress depth as measured form the upper surface 370t of the master slide 370c to the depression bottom 312mdb at least 0.5 to 0.75 inches, with the mount rim 312mr extending 0.2 to 0.4 inches inward from the inner wall 312iw of the mount depression 312md and having a rim thickness at the mount opening 312mo as measured from the upper surface 370t to the rim underside 312ru, the rim thickness configured and sized to be 0.02 inches less than a mount foot shaft thickness 312mfst that is as measured from the hold 312h to a bottom side 313b of the removable handle first portion 312a. The hold 312h is sized to fit under the mount rim 312mr and is 3 times a width of the mount slot 312ms as measured around the inner wall 312iw of the mount depression 312md parallel to the mount depression bottom 312mdb. The mount slot 312ms may be 0.125 to 0.25 inches as measured parallel to the mount depression bottom 312mdb. The first bristle bundles 18f of the first bristles 20f may be anchored in the first slide head 370f and the second bristle bundles 18s of the second bristles 20s may be anchored in the second slide head 370s using any one of the methods discussed for the head base 15 of the one embodiment of the present invention and shown in FIGS. 2, 3, 4, 6A, 6B, and 6C. The second rear mount handle 112 of FIG. 9 may also be attached to the dual slide head coil brush 310 shown in FIG. 17. The plate bottom side 12m1d of the second rear mount handle 112 of FIG. 9 may also be attached to the upper side 370t of the master slide 370c of the dual slide head coil brush 310 shown in FIG. 17 by using an adhesive, screws, or a bolt.

Although the bristles 20 shown in FIG. 1 contain only one bristle 20, each bristle bundle 18 may consist of more than one bristle 20. Likewise the first bristle bundles 18f each may have more than one first bristle 20f, and the second bristle bundles 18s each may have more than one second bristle 20s. Although the bristles 20 shown in FIG. 2 are bent, the one or more bristle bundles 18 may consist of bristles 20 that are straight as shown in FIG. 4 where the base portion 22, the mid portion 23 and the forward portion 24 may be aligned along the mid base axis 25, or the bristles 20 each may be bent relative to the mid base axis 25 at a bristle angle 26, the bristle angle 26 ranging between and including 115° and −115° as measured from the mid base axis 25. Like wise the first bristle bundles 18f and the second bristle bundles 18s may have more than one first bristle 20f and more than one second bristle 20s, respectively, for each of the another embodiment, the yet another embodiment, and the still yet another embodiment of present invention.

The head base 15; the first head base 115f and the second head base 115s; the slide heads, such as the first slide head 370f; the master slide 370c, the slides, such as the first slide 16f; and the handle, such as the rear mount handle 12, may be manufactured of any suitable material known in the art, for example, polymeric materials or copolymers, polypropylene, PBT, nylon, metal, wood, fiberglass, etc., and combinations thereof. The head base 15; the first head base 115f and second head base 115s; the slide heads, such as the first slide head 370f; the master slide 370c, and the slides, such as the first slide 16f may be rectangular shaped with the bristle bundles 18 disposed parallel to each other. The head base 15 may be used to grip and hold the coil brush 10 or an exemplary embodiment of the invention, the coil brush 10 with the rear mount handle 12, may have all the component parts of the coil brush 10 plus the rear mount handle 12 extended from the head base rearward end 15b of the coil brush 10 to form the coil brush 10 with the rear mount handle 12.

The brush head 14 has a head base 15 with a head base forward end 15a and a head base rearward end 15b, with the bristle bundles 18 inserted in the head base forward end 15a using any suitable technique known, for example: adhesives, mechanical fasteners, wires, thermal or chemical welding, pressure, etc. The arrangement of the bristle insertion may take the any suitable form of parallelogram with base portion 22 and the mid portion 23 of the bristles 20 in the bristle bundles 18 parallel to any of the base portion 22 and mid portion 23 of the other bristle bundles 18. An arrangement of the bristles 20 inserted in the base portion 15 may be in rows, such as the first row 216fr for the first bristles 20f and the second row 216sr of second bristles 20s, as illustrated in FIG. 15.

In the head base 15 of the brush head 14 where the bristle bundles 18 of bristles 20 are inserted, the bristle bundles 18 may have comprise bristles 20 different sizes, shapes and designs of placement as well as different characteristics that modify the surface of the brushing plane or bristle surface, providing additional surfaces of brushing plane.

It is understood that elements with the same numeral and alphabetical identifier are like elements.

Having sufficiently described the invention in the preceding paragraphs, what is contained in the following claims is what is claimed as intellectual property.

What is claimed is:

1. A coil brush, comprising a brush head; the brush head having a head base, a brush slide and bristle bundles; the head base having a head base forward end and a head base rearward end; the bristle bundles each having at one or more bristles; the one bristle comprising a base portion, a mid portion and a forward portion; the mid portion located between the base portion and the forward portion; the base portion inserted through the brush slide and through the head base forward end into the head base; the base portion and the mid portion of the one bristle aligned along a mid base axis; and the forward portion having a distal end.

2. The coil brush according to claim 1, wherein the distal end of the forward portion of the one bristle points in the direction of the head base forming a hook.

3. The coil brush according to claim 1, wherein the forward portion of the one bristle is bent relative to the mid base axis forming a bristle angle.

4. The coil brush according to claim 3, wherein the bristle angle is between and including 115° and −115°.

5. The coil brush of claim 1 wherein the brush head further comprises at one or more rails to form a first brush head; the one rail parallel to any other rail of the first brush head, the one rail disposed on the head base to form a first head base of the first brush head; the bristle bundles also being first bristle bundles; the one bristle being a first bristle; the first brush head having the first bristle bundles of the first bristles; the brush slide being a first slide; and the first bristle bundles disposed through the first slide into and into the first head base.

6. The coil brush of claim 5 further comprising a second brush head; the second brush head comprising a comprising a second slide; a second head base, and second bristle bundles of second bristles; the second head base having one or more tracks; the one track parallel to any other track; the one or more rails of the first head base configured for sliding in the one or more tracks of the second head base; the second bristle bundles of the second bristles inserted through the second slide and into the second head base; and the second bristles each configured with the base portion, the mid portion, the forward portion and the mid base axis like the one bristle of the brush head.

7. The coil brush of claim 6 wherein the forward portions of the first bristles each have a first bristle angle with the mid base axis; and wherein the forward portion of the second bristles each have a second bristle angle with the mid base axis.

8. The coil brush of claim 7 wherein the first bristle angle is between 115° and −115°; and the second bristle angle is between 115° and −115°.

9. The coil brush of claim 6 wherein the forward portions of the first bristles in the first head base each have a first bristle angle with the mid base axis; the first bristle angle ranging between 115° and −115°; and wherein distal ends of the forward portions of the second bristles each points in the direction of the second head base to form a hook.

10. The coil brush of claim 7 further comprising a rear mount handle; the rear mount handle having a handle first end and a handle near end; the handle first end opposite the handle near end; the handle first end connected to the head base rearward end of the first head base.

11. A coil brush comprising a brush head, a slide mount, a first slide and a second slide; the brush head having a head base and first bristle bundles of first bristles; the slide mount having second bristle bundles of second bristles and one or more slide apertures; the one or more slide apertures disposed on a first row for the first bristle bundles of the first bristles disposed there through; the slide mount configured to slide along the first bristles of the first bristle bundles; the first slide and the second slide having bristle aperture; the first bristle bundles of the first bristles inserted through the bristle apertures of the first slide and through the slide apertures of the slide mount through a head base forward end of the head base into the head base; the second bristle bundles of the second bristles inserted through the bristle apertures of the second slide and through a slide forward end of the slide mount into the slide mount; the first bristles and the second bristles each having a base portion, a mid portion, and a forward portion; the mid portion located between the base portion and the forward portion; and the mid portion having a mid base axis.

12. The coil brush of claim wherein the forward portion of the first bristles in the head base have a first bristle angle with the mid base axis; and wherein the forward portion of the second bristles in have a second bristle angle with the mid base axis.

13. The coil brush of claim 12 wherein the first bristle angle is between 115° and −115°; the second bristle angle is between 115° and −115°.

14. The coil brush of claim 12 wherein the first bristle angle is between 115° and −115°; and wherein each the second bristle angle is greater than −90 degrees forming a hook.

15. A coil brush comprising a first slide head, a second slide head, a master slide, a first slide and a second slide; the first slide head having first bristle bundles of first bristles; the second slide head having second bristle bundles of second bristles; the master slide having master first apertures configured for the first bristle bundles of the first bristles; the master slide having master second apertures configured for the second bristle bundles of the second bristles; the master slide configured to slide on the first bristle bundles of the first bristles and the second bristle bundles of the second bristle; the first slide and the second slide having bristle apertures; the first bristle bundles of the first bristles inserted through the bristle apertures of the first slide and through the master first apertures of the master slide and into the first slide head; the second bristle bundles of the second bristles inserted through the bristle apertures of the second slide and through the master second apertures of the master slide and into the second slide head; each of the first bristles and each the second bristles having a base portion, a mid portion, and a forward portion; the mid portion located between the base portion and the forward portion; and the mid portion having a mid base axis; and the forward portion having a distal end.

16. The coil brush of claim 15 further comprising a handle; the handle disposed attached to a top side of the master slide.

17. The coil brush of claim 15 further comprising a removable handle having a mount foot with a hold and a stub; the mount foot configured to fit in a mount depression of the master slide; the removable handle configured to detach form the master slide by rotating the removable handle through 180 degrees with the stub in a mount slot of a handle depression; the handle depression located on a top side of the master slide.

18. The coil brush of claim 15 wherein each of the forward portions of the first bristles has a first bristle angle with the mid base axis; and wherein each of the forward portions of the second bristle has a second bristle angle with the mid base axis.

19. The coil brush of claim 18 wherein the first bristle angle is between and including 115° and −115°; and the second bristle angle being between and including 115° and −115°.

20. The coil brush of claim 18 wherein the first bristle angle is between and including 115° and −115°, and wherein the second bristle angle is greater than −90 degrees forming a hook.
